(19) United States
(12) Patent Application Publication
(10) Pub. No.: US 2002/0129044 A1
(43) Pub. Date: Sep. 12, 2002

(54) Data-processing and information system

(76) Inventor: Mario Jeckle, Senden (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/074,205

(22) Filed: Feb. 12, 2002

(30) Foreign Application Priority Data
Mar. 10, 2001 (DE) DE 101 11 537.7

(51) Int. Cl. G06F 12/00

(52) U.S. Cl. 707/201

(57) ABSTRACT

For a system-linking network of different software and hardware systems, a data-processing and information system (1) having a multiplicity of data-processing units (2) is provided according to the present invention for different process and/or product phases, which have application-specific languages and/or data models that are different from each other, wherein an abstraction model (12) is provided for detecting and representing an element affected by a process and/or product modification, on the basis of an object class (OK1 through OKn) using a modeling of data (D1 through D4) characterizing the relevant process sequences and the relevant product structures.

Priority to German Patent Application No. 101 11 537.7, filed Mar. 10, 2001 and hereby incorporated by reference herein, is claimed.

### BACKGROUND INFORMATION

The present invention relates to a data-processing and information system, specifically a computer-supported engineering, design, project planning, distribution, execution, and/or service system, which is set up in a decentralized or distributed manner.

Due to the complexity of distributed, computer-supported data-processing and information systems of this type, the latter have a multiplicity of programming and implementing languages, of data types and data models, which in turn are applied on various hardware devices or platforms. For one process sequence, e.g., one planning sequence or product sequence, from designing to servicing, the sequences must therefore be coordinated on the various hardware devices. In this context, in the various phases of one process sequence, different data or even different views of the same data are required. For example, a technical designer needs a high-resolution representation for a machine part, specifically a three-dimensional view, of the machine part, whereas servicing only requires an image of the machine part. In addition, the result of the increasing globalization of the economy and industry is that technical designers work on one and the same machine part at different times, in different time zones, in different languages, and using different hardware devices.

Such a heterogeneity of data, languages, times, software, hardware, and/or versions of applications leads to a loss in productivity in the design, development, and manufacture of products. Therefore, everyone participating in the process is usually restricted with regard to language, data, hardware, and software, one widely used platform of one manufacturer becoming the focus of the work. The dependencies that result therefrom lead to a loss of flexibility in the individual process segments. In addition, the cost of coordination and consultation is significantly increased due to the absence of transparency between the partial processes of the participants and between individual process segments or development segments of the product cycle. The result is often data, model, and/or language inconsistencies, which can be removed only on the basis of increased outlays of time and money. In addition, cumbersome project plans and interface adjustments are necessary due to the multiplicity of systems, the heterogeneity of the systems, and the absence of standards.

### SUMMARY OF THE INVENTION

Therefore, an objective of the present invention is to provide a data-processing and information system which makes possible, in a particularly simple manner, a system-linking network of different software and hardware systems.

The objective may be achieved according to the present invention by a data-processing and information system that includes a multiplicity of data-processing units for different process and/or product phases, which have application-specific languages and/or data models that are different from each other, an abstraction model being provided for the detection and representation of an element that is affected by a process and/or product change, on the basis of a product class, using a modeling of data characterizing the relevant process sequences and relevant product structures. A system-independent abstraction model of this type, e.g., a modeling language, based on a plurality of defined object classes for the totality of the system makes possible high system stability and consistency of all data and/or languages used in the system, as well as high performance. In this context, the object class advantageously defines, in a clear manner, the elements or objects that characterize the different partial systems, on the basis of a defined minimum quantity of attributes. In this manner, in all process and/or product phases, one single and therefore consistent classification is given to all elements in the system on the basis of object classes. In this context, the abstraction model makes possible user- and task-dependent views of product data, in particular of distributed product data. In addition, an abstraction model of this type makes possible the control and monitoring of location-overlapping and distributed processes. In this way, the coordination of distributed development phases is made possible at different locations.

The abstraction model can advantageously be visualized using the corresponding object classes. In this context, a uniform surface is provided that is independent of the hardware and software environment relating to the specific location, e.g., a window for an interactive operator control in the online generating, modifying, and actualizing of the abstraction model, specifically of the object classes. In addition, the uniform surface makes possible a plausibility check with respect to consistency between object classes of different partial systems in the overall system.

Advantageously, the abstraction model is provided for the retrieval of application-specific languages and/or data models on the basis of the object classes. Specifically, as a result of the uniform abstraction model of all process and/or product phases in the distributed system, both so-called forward engineering as well as reverse engineering are made possible. The abstraction model is advantageously provided for process chain modeling. In this context, by specifying all objects of a process chain on the basis of defined object classes, it is possible, through additional object classes that can be expanded indefinitely, to describe, for example, the development process of a product, but also the subsequent life phases of a product.

The abstraction model on the basis of object classes preferably functions as input datum for transformation algorithms in order to obtain other application-specific languages and/or data models. In this manner, the system, language, and data-model-independence of the abstraction model is given, the latter having one component for the object classes having the smallest possible number of interfaces, which are supplied to the transformation algorithm.

The advantages achieved by the present invention can be especially seen in the fact that, as a result of the uniform abstraction model describing all distributed systems, a uniform platform is given for communication between different participants in one process sequence. As a result, efficient control of different process sequences, high process reliability, and high process transparency are made possible. In particular, the functional and data-technical integration of different technologies, applications, and platforms is made possible.

### BRIEF DESCRIPTION OF THE DRAWINGS

Exemplary embodiments of the present invention are discussed in greater detail on the basis of the drawings in which:

FIG. 1 schematically depicts a data-processing and information system having an abstraction model, and

FIG. 2 schematically depicts the abstraction model for an application having corresponding object classes.

Parts that correspond to each other in all of the Figures are provided with the same reference numerals.

### DETAILED DESCRIPTION

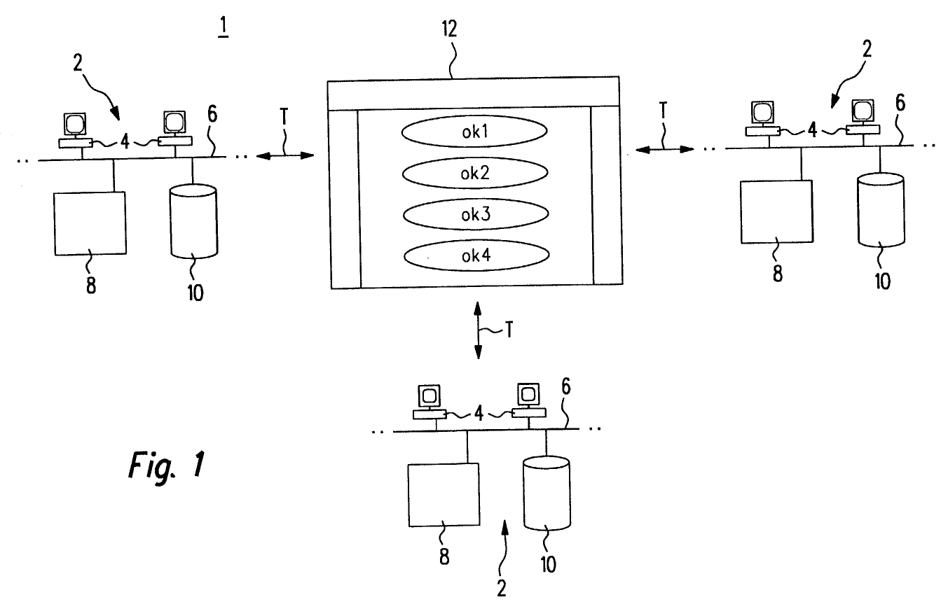

FIG. 1 depicts a data-processing and information system 1 having a plurality of data-processing units 2. Data-processing units 2, in this context, include in each case an operating and observation system 4, a local data transmission unit 6, a computing unit 8, and a storage unit 10. Data-processing units 2 can be, for example, a personal computer, a workstation, or another data-processing unit.

Specific data-processing unit 2 is characterized by a function that is carried out in a complex method or process and by a hardware and software structure that is necessary for this function, such as workstation or PC, programming or modeling languages and/or data models. For example, in a location-independent method for developing a product, distributed data-processing units 2 are provided with different functions, such as one for the design of the product, one for the development of the control software, one for the assembly, one for the administrative functions (e.g., selection of suppliers), which are heterogeneous with respect to each other especially with regard to their hardware and software structure.

Abstraction model 12 is provided for the detection and system-independent conceptual representation of an element or system part representing one process sequence and/or one product structure. Abstraction model 12, in this context, includes a modeling language for modeling dynamic and/or static process sequences, for modeling product structures or partial elements of the product, for coordinating all the participants in the process or method, for modeling communications sequences between linked data-processing units 2 on the basis of a specifiable number of object classes OK1 through OKn using the relevant data for the process sequence, the product structure, etc.

The models generated using abstraction model 12 function as input and/or output data for any transformation algorithms T for specific data-processing unit 2 or between data-processing units 2. The generation of logical models of this type, which are stable with respect to change and oriented to objects, can be converted into any physical implementing structures, such as object-oriented programming languages Java, C++, object-oriented databases, or XML languages. As a result of the application of transformation algorithm T characterizing specific data-processing unit 2, application-specific languages and/or data models of data-processing unit 2 in question can be generated or retrieved on the basis of object classes O.

Abstraction model 12 especially functions to collect and recognize incompletely recorded data or information within one individual data-processing unit 2 or data to be exchanged between a plurality of data-processing units 2. In addition, abstraction model 12 makes possible a plausibility check with respect to the consistency between the different product and/or process phases for one product, this being within an individual data-processing unit 2 and/or with respect to the consistency of data, partial processes, etc., of a plurality of data-processing units 2, which are accordingly linked with each other and which fulfill a specific function within the entire process. Thus, using abstraction model 12 created within data-processing and information system 1, for engineering during a product development process and during the subsequent service-life phases of the product, consistent objects on the basis of object classes O are generated and administered for indefinitely extendable additional product structures or phases. Depending on the type and design of data-processing and information system 1, abstraction model 12 is generated and processed centrally. Alternatively, for a plausibility check, a plurality of abstraction models 12 are generated in a location-, process-, product-, phase-, and/or application-specific manner. An abstraction model 12 of this type therefore acts to implement software and hardware in a complex overall process, as a result of which the overall process chain can be modeled.

Abstraction model 12 can be visualized in accordance with the type and design of data-processing and information system 1, in particular of data-processing units 2. Using the window, abstraction model 12 is successively set up and/or modified on the basis of object classes OK1 through OKn. For this purpose, a corresponding interactive operating surface is provided, for example, on the basis of operating and observing system 4 of specific data-processing unit 2, using which a user can insert application-specific modifications, on the basis of which corresponding object classes OK1 through OKn and therefore abstraction model 12, is adjusted.

Abstraction model 12 is described as follows in an example for the development and design of a new element, e.g., a control board, in an existing product, e.g., a motor. By integrating the new control board into the existing product, different process and product changes are necessary, such as the design of the new board, installation of the new board, mounting support for the new board, software for the new board. Depending on the type and design of data-processing and information system 1, the latter includes, for the identified process sequences and/or product structures and/or changes, one or more data-processing units 2 having different hardware and software structures and having associated abstraction models 12. Abstraction models 12, in this context, are independent of the hardware and software structure characterizing data-processing unit 2 in question.

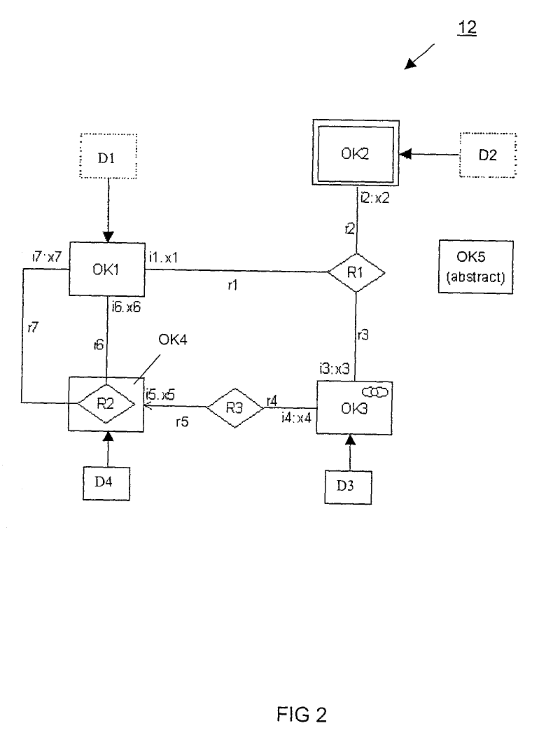

In FIG. 2, by way of example, a part of one of abstraction models 12 is depicted, such as can be visualized, for example, on a video screen, for an application, e.g., for the detection and creation of the partial process, “Production and Overall Assembly,” including the installation of the board on the basis of a mounting support on the motor. Abstraction model 12 for this purpose defines the mounting support or attributes relating to the board or data D1 or D2, such as dimensions or operating parameters, which in turn function to describe and model appropriate object classes OK1 or OK2. In this context, the entity type or object class OK1 represents the mounting support, and the entity type or object class 2 represents the board. Data D3 or D4 function to describe object classes OK3 and OK4, object class OK3 representing a housing, and object class OK4 representing the motor. For example, in this context, object class OK5 functions to abstract one element. Reciprocal actions of the elements, such as adjusting the mounting support to the board and to the housing or adjusting control parameters/functions of the board to the control/regulation of the motor, are described on the basis of relations, r1 through r7, R1, R3, it being the case that relations r1 through r7 describe unilateral relations, and relations R1, R3 describe bilateral relations. The functions underlying the roles or relations r1 through r7, R1, R3 also have corresponding, specifiable value ranges il:x1 through i7:x7.

In one alternative exemplary embodiment, object classes OK1 and OK2 each represent a data-processing system 2 having different functions, e.g., one for project planning, the other for operating and monitoring or simulating the automation process. In this context, object class OK3 represents, for example, a data transmission unit, which physically links both data-processing systems 2 to each other. Specific object classes OK1 through OK4 are characterized by respective associated data D1 through D2, describing the underlying element. In this context, a plurality of semantically equivalent signs or elements of abstraction model 12 are described by one single object class OK1 through OK4. Moreover, one single element can be described on the basis of relations R1 or R3 of relevant object class OK3 using other object classes OK2 or OK4, which are in a reciprocal relationship with the former. In this context, every relation R1 or R3 is described by its underlying function or role r2, r3, or r4, r5 as well as by a value range i2:x2, i3:x3, or i4:x4, i5:x5, representing this role. In a unilateral exchange or effect, object class OK1 in question is described by the corresponding function or role r1 and r7 having value range il:x1 or i7:x7, respectively.

Abstraction model 12 has for relevant data-processing units 2 in each case an appropriate transformation algorithm for converting abstraction model 12 into the language, data, and/or models characterizing respective data-processing unit 2. In this context, specific abstraction model 12, as a function of the number of data-processing units 2, includes associated user- and/or task-dependent abstraction models 12, e.g. 12A through 12Z, which on a uniform basis can be converted into the respective environment of corresponding data-processing unit 2.

Object classes OK1 through OKn function as attributes for relevant transformation algorithm T of respective data-processing unit 2. In this context, different data-processing units 2 within data-processing and information unit 1, and therefore within the system, are in functional connection with each other only via abstraction models 12.

On the basis of an abstraction model 12 of this type, including a number of models and representing the entire process, it is possible using individual abstraction models 12 to derive model information from already existing or adjoining abstraction models 12 and their underlying process and/or product structures using transformation algorithm T. Thus, using abstraction models 12, a homogeneity is possible among all data-processing units 2 making up the process and the system on the basis of a uniform object-oriented modeling for a number of minimum functions, such as communication, data, process, management, on the basis of abstraction model 12. Depending on the type and design, abstraction models 12 can be set up hierarchically; for example, a plurality of lower-level abstraction models 12 can be described and modeled by a higher-level superordinate abstraction model 12.

What is claimed is:

1. A data-processing and information system comprising:
a plurality of data-processing units for different process and/or product phases, which have application-specific languages and/or data models that are different from each other, and
an abstraction model for detecting and representing an element affected by a process and/or product modification, on the basis of an object class using a modeling of data characterizing process sequences related to the process phase and product structures related to the product phase.

2. The data-processing and information system as recited in claim 1, wherein the abstraction model can be visualized using the appropriate object classes.

3. The data-processing and information system as recited in claim 1, wherein a plurality of semantically equivalent elements of the abstraction model can be described by one single object class.

4. The data-processing and information system as recited in claim 3, wherein one single element of the abstraction model can be described on the basis of relations of the single object class to other object classes that stand in a reciprocal relation with the single object class.

5. The data-processing and information system as recited in claim 1, wherein the abstraction model is provided as input data for transformation algorithms for generating other application-specific languages and/or data models on the basis of the object class.

6. The data-processing and information system as recited in claim 1, wherein the abstraction model is provided for process chain modeling.

7. A method for operating a data-processing and information system comprising:
operating a plurality of data-processing units for different process and/or product phases, which have application-specific languages and/or data models that are different from each other, and
providing an abstraction model for detecting and representing an element affected by a process and/or product modification, on the basis of an object class using a modeling of data characterizing process sequences related to the process phase and product structures related to the product phase.
